(19) United States
(12) Patent Application Publication
(10) Pub. No.: US 2026/0316451 A1
(43) Pub. Date: Oct. 15, 2026

(54) LIQUID EJECTION HEAD AND LIQUID EJECTION APPARATUS

(71) Applicant: CANON KABUSHIKI KAISHA, Tokyo (JP)

(72) Inventors: KATSUHIRO MATSUDA, Kanagawa (JP); YOHEI NAKAMURA, Kanagawa (JP); TOMOHIRO SATO, Tokyo (JP)

(21) Appl. No.: 19/644,068

(22) Filed: Apr. 10, 2026

(30) Foreign Application Priority Data
Apr. 11, 2025 (JP) 2025-065450

(51) Int. Cl. B41J 2/14

(52) U.S. Cl. CPC B41J 2/14233; B41J 2002/14258; B41J 2002/14306

(57) ABSTRACT

A technology is provided for suppressing deterioration of a piezoelectric actuator in a liquid ejection head that uses the piezoelectric actuator to vibrate a meniscus and circulate ink through a channel. To this end, the piezoelectric actuator has a configuration including a plurality of laminated piezoelectric layers and three electrodes provided so as to sandwich the piezoelectric layers therebetween in a laminated direction.

### BACKGROUND

### Field of the Technology

The present disclosure relates to a liquid ejection head and a liquid ejection apparatus.

### Description of the Related Art

Japanese Patent Laid-Open No. 2019-098614 describes a method for suppressing ink thickening by vibrating the meniscus formed in a nozzle or circulating ink through an individual channel and a manifold channel by vibrating a piezoelectric actuator at a predetermined frequency.

In a case of using the piezoelectric actuator to circulate the ink or vibrate the meniscus, the total drive time of the piezoelectric actuator is longer than that in a case of using the piezoelectric actuator only for ink ejection. In such a case, the number of piezoelectric actuators driven for ink circulation and meniscus vibration is 10 to 100 times the number of piezoelectric actuators driven for liquid ejection.

The piezoelectric actuator has a limited lifetime. It is known that the lifetime shortens as the number of piezoelectric actuators driven increases.

In a case of using a piezoelectric actuator as described in Japanese Patent Laid-Open No. 2019-098614 to vibrate the meniscus formed in a nozzle or circulate the ink, there is a possibility that the lifetime of the liquid ejection head is shortened by deterioration of the piezoelectric actuator, compared to a case of using the piezoelectric actuator only for ink ejection.

### SUMMARY

Therefore, the present disclosure provides a technology for extending the lifetime of a piezoelectric actuator in a liquid ejection head using the piezoelectric actuator to vibrate the meniscus and circulate ink through a channel.

To that end, a liquid ejection head of the present disclosure is a liquid ejection head including: an ejection port for ejecting a liquid; a pressure chamber communicating with the ejection port; a piezoelectric actuator for applying pressure to the liquid contained in the pressure chamber; an ejection passage connecting the pressure chamber to the ejection port; a common channel capable of containing the liquid to be supplied to a plurality of the pressure chambers; an individual supply channel for supplying the liquid from the common channel to the pressure chamber; and an individual collecting channel for collecting the liquid from the ejection passage to the common channel, wherein the piezoelectric actuator has a plurality of piezoelectric layers laminated in a laminated direction, and a first electrode, a second electrode, and a third electrode, which are provided at different positions in the laminated direction so as to sandwich the piezoelectric layers different from each other.

The present disclosure can provide a technology for suppressing deterioration of a piezoelectric actuator in a liquid ejection head that uses the piezoelectric actuator to vibrate a meniscus and circulate ink through a channel.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic configuration diagram of a liquid ejection apparatus;

FIG. 2A is a diagram showing a liquid ejection head;

FIG. 2B is a diagram showing a liquid ejection substrate;

FIG. 3 is a top view showing a part of the liquid ejection head;

FIG. 4A is a diagram showing a piezoelectric actuator;

FIG. 4B is a diagram showing a channel unit and the piezoelectric actuator;

FIG. 4C is an enlarged cross-sectional view showing an ejection port;

FIG. 5 is a block diagram showing a control system of the liquid ejection apparatus;

FIG. 6 is a diagram showing an equivalent circuit of fluid movement in an individual channel and the piezoelectric actuator;

FIG. 7 is a graph showing an example of a relationship between gain and drive frequency in a meniscus of the ejection port and in an individual collecting channel;

FIG. 8A is a chart showing an example of a drive waveform of the piezoelectric actuator;

FIG. 8B is a chart showing an example of the drive waveform of the piezoelectric actuator;

FIG. 8C is a chart showing an example of the drive waveform of the piezoelectric actuator;

FIG. 9A is a diagram showing the piezoelectric actuator;

FIG. 9B is a diagram showing the channel unit and the piezoelectric actuator;

FIG. 10A is a diagram showing the piezoelectric actuator;

FIG. 10B is a diagram showing the channel unit and the piezoelectric actuator;

FIG. 11A is a diagram showing the piezoelectric actuator; and

FIG. 11B is a diagram showing the channel unit and the piezoelectric actuator.

### DESCRIPTION OF THE EMBODIMENTS

### First Embodiment

A first embodiment of the present disclosure will be described below with reference to the drawings. In each of the following embodiments, a liquid ejection head for ejecting ink and a liquid ejection apparatus will be described using specific configurations, but the present disclosure is not limited thereto. A liquid supply method used for the liquid ejection head and the liquid ejection apparatus of the present disclosure is applicable to apparatuses such as a printer, a copier, a facsimile with a communication system, and a word processor with a printer unit, and also to an industrial printing apparatus combined with various processing apparatuses. For example, the liquid supply method can also be used for applications such as biochip production and electronic circuit printing.

The embodiments described below are specific desirable examples of the present disclosure, and therefore various technically desirable limitations are imposed thereon. However, as long as in line with the idea of the present disclosure, the present embodiment is not limited to the embodiments described herein or other specific methods.

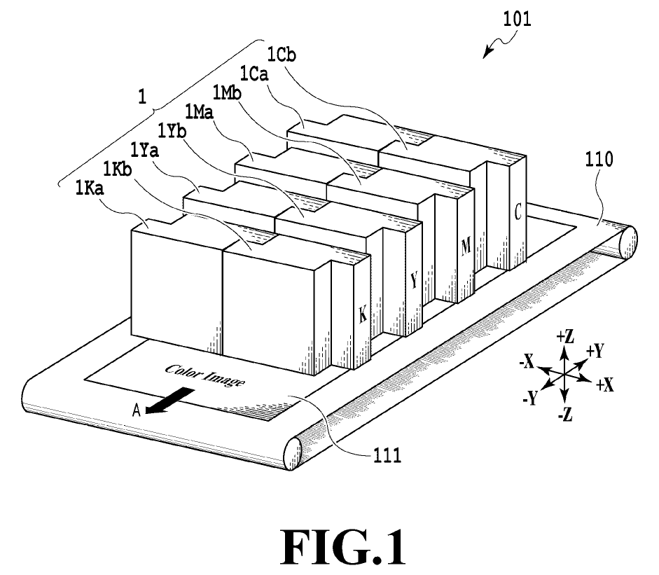

FIG. 1 is a schematic configuration diagram of a liquid ejection apparatus 101 to which the present embodiment can be applied. The liquid ejection apparatus 101 is a one-pass type printing apparatus capable of mounting a liquid ejection head 1 and configured to print an image by ejecting a liquid from the liquid ejection head 1 onto a printing medium 111 in a single movement of the printing medium 111. The liquid ejection head 1 has ejection ports arrayed over the length corresponding to the full width of the printing medium 111. The printing medium 111 is conveyed in a -Y direction by a conveying unit 110, and printing is performed by the liquid ejection head 1. The liquid ejection head 1 can be implemented in any configuration, including the example of FIG. 1, and is not limited for other configurations. For example, the liquid ejection head 1 may be a serial-type liquid ejection head for printing by alternately repeating the movement of the printing medium and the movement of the liquid ejection head.

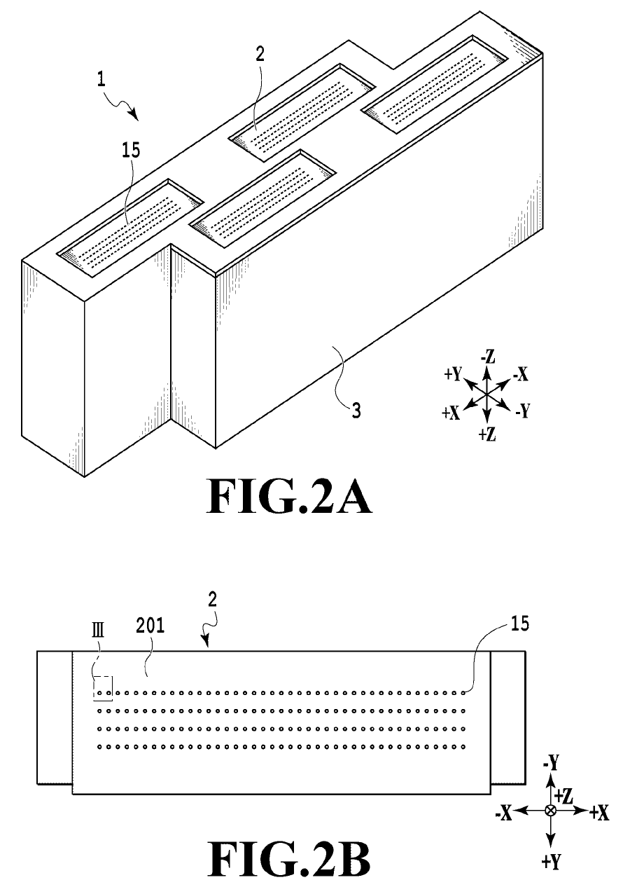

FIG. 2A is a perspective view of the liquid ejection head 1. FIG. 2B is a diagram showing a liquid ejection substrate 2. The liquid ejection head 1 has a plurality of liquid ejection substrates 2 disposed in a head main body 3. Ink ejected by the liquid ejection head 1 is supplied from an ink tank (not shown) to the liquid ejection substrate 2 through a common supply port (not shown) in the head main body 3. The liquid ejection substrate 2 has a plurality of ejection ports 15 formed in arrays, and the ejection ports 15 are arranged along the longitudinal direction of an ejection port substrate 201 to form a plurality of ejection port arrays. The ink passes through channels inside the liquid ejection substrate 2, and is ejected from the ejection ports 15 and applied onto the printing medium 111. An electric substrate (not shown) is also disposed in the head main body 3 to supply power and signals required for ejecting the ink from the ejection ports 15. The electric substrate is connected by terminals (not shown) and wiring (not shown) of the liquid ejection substrate 2.

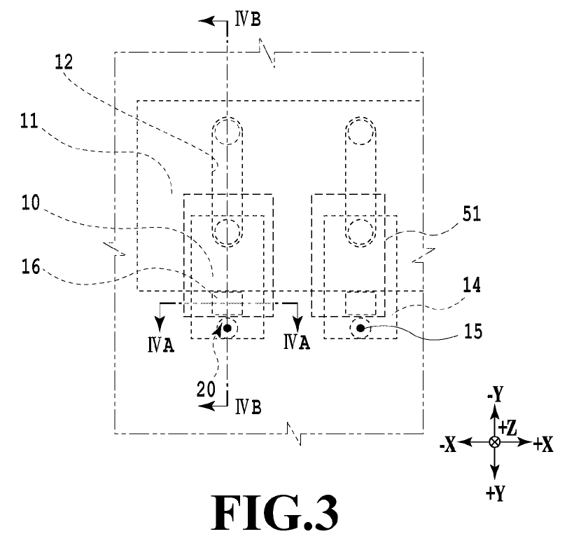

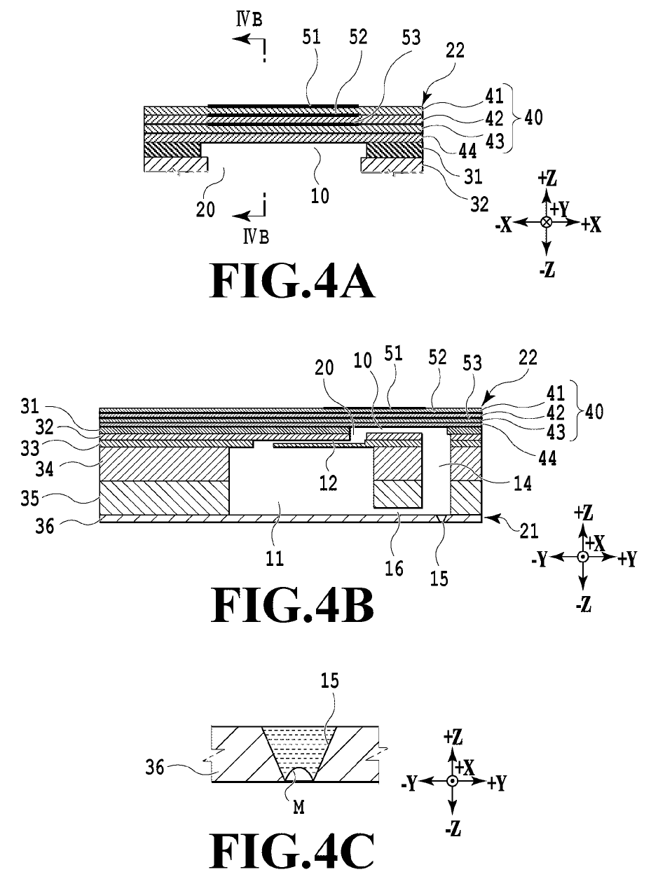

FIG. 3 is a top view showing a part of the liquid ejection head 1, and corresponds to an enlarged view of portion III shown in FIG. 2B. FIG. 4A is a cross-sectional view taken along line IVA-IVA in FIG. 3. FIG. 4B is a cross-sectional view taken along line IVB-IVB in FIG. 3. FIG. 4C is an enlarged cross-sectional view showing the ejection port 15.

The liquid ejection head 1 includes the ejection ports 15, a channel unit 21 in which ink channels including individual pressure chambers 10 and the like are formed, and a piezoelectric actuator 22 for applying pressure to the ink in the individual pressure chambers 10. The channel unit 21 is a multilayer body formed by laminating six plates 31 to 36 (see FIG. 4B). A plurality of individual channels 20 and a common channel 11 are formed in the channel unit 21. The individual channels 20 each include the ejection port 15, the individual pressure chamber 10, an ejection passage 14 connecting the ejection port 15 and the individual pressure chamber 10, an individual supply channel 12 connecting the common channel 11 and the individual pressure chamber 10, and an individual collecting channel 16 connecting the ejection passage 14 and the common channel 11. The individual channel 20 also includes the piezoelectric actuator 22 for applying pressure to the individual pressure chamber 10. The ejection port 15 is formed so as to penetrate the plate 36.

The individual pressure chamber 10 is formed so as to penetrate the plate 31. The individual pressure chamber 10 has a substantially rectangular planar shape with a Y direction being the longitudinal direction. The individual pressure chamber 10 overlaps with the ejection port 15 at an end portion thereof in a +Y direction as viewed along a Z direction. The ejection passage 14 is provided so as to penetrate the plates 32 to 35, and connects the ejection port 15 to the individual pressure chamber 10. The ejection passage 14 is provided so as to be able to transmit pressure generated in the individual pressure chamber 10 to the ejection port 15. The common channel 11 is formed so as to penetrate the plates 34 and 35. The individual supply channel 12 connecting the common channel 11 to the individual pressure chamber 10 is formed across the plates 32 and 33. The individual supply channel 12 extends along the upper surface of the plate 33, and has one end connected to the end portion of the individual pressure chamber 10 and the other end connected to the common channel 11. The individual collecting channel 16 connecting the ejection passage 14 to the common channel 11 is formed in the plate 35, and extends in the Y direction along the surface of the plate 35. The individual collecting channel 16 connects the ejection passage 14 to the common channel 11.

The piezoelectric actuator 22 includes: a piezoelectric body 40 having a plurality of piezoelectric layers laminated in the Z direction, which intersects with the Y direction; a first electrode 51; a second electrode 52 spaced apart from the first electrode 51 in the Z direction; and a third electrode 53 spaced apart from the first electrode 51 in the Z direction. The piezoelectric actuator 22 is laminated on the channel unit 21 in the Z direction and disposed on the upper surface of the plate 31. The piezoelectric actuator 22 has an ink separation layer 44, and the piezoelectric body 40 has three piezoelectric layers 41 to 43 laminated in the Z direction. The ink separation layer 44 is disposed on the plate 31 and covers all of the individual pressure chambers 10 formed in the plate 31. The ink separation layer 44 is made of, for example, a metal material such as stainless steel, a piezoelectric material composed mainly of lead zirconate titanate, a synthetic resin material, or the like.

The piezoelectric layer 43 is disposed on the ink separation layer 44. The piezoelectric layer 42 is disposed on the piezoelectric layer 43. The piezoelectric layer 41 is disposed on the piezoelectric layer 42. The piezoelectric layers 41 to 43 each overlap with the ink separation layer 44 in the Z direction. The piezoelectric layers 41 to 43 are made of a piezoelectric material composed mainly of lead zirconate titanate. The piezoelectric actuator 22 deforms the piezoelectric body 40 and the ink separation layer 44, thereby pressurizing the liquid in the individual pressure chambers 10 to eject liquid droplets from the ejection ports 15, vibrating the meniscus of the ejection ports 15, and circulating ink inside the channel unit. Note that the material for the piezoelectric layer 43 is not limited to the piezoelectric material.

Specifically, before the liquid ejection head 1 is operated, the first electrode 51 and the third electrode 53 are set to a ground potential (hereinafter referred to as GND), and the second electrode 52 is set to a potential Va (≠ 0). At this time, a potential difference between the first electrode 51 and the second electrode 52 and a potential difference between the second electrode 52 and the third electrode 53 cause the piezoelectric layers 41 and 43 to contract and warp in the XY plane. As a result, the piezoelectric body 40 having the plurality of piezoelectric layers laminated in the Z direction and the ink separation layer 44 become convex downward (in the -Z direction) toward the individual pressure chamber 10, and the inner volume of the individual pressure chamber 10 becomes smaller than that in a case where the piezoelectric body 40 is flat.

In a case of operating the liquid ejection head 1 to eject ink from the ejection port, first, the potential of the corresponding first electrode 51 is switched from GND to the potential Va. In this event, the potential difference between the first electrode 51 and the second electrode 52 is eliminated, releasing the contraction of the piezoelectric layer 41 between the first electrode 51 and the second electrode 52. The downward convexity is thus eliminated, making the piezoelectric body 40 substantially flat. As a result, the inner volume of the individual pressure chamber 10 becomes larger than that before operation, and the amount of ink in the individual pressure chamber 10 increases. As the corresponding first electrode 51 is then switched from the potential Va to GND, the potential difference between the first electrode 51 and the second electrode 52 and the potential difference between the second electrode 52 and the third electrode 53 cause the piezoelectric layers 41 and 43 to contract and warp in the XY plane, as in the case before operation. As a result, the increased inner volume of the individual pressure chamber 10 returns to its original state before operation, and the ink increased in the individual pressure chamber 10 is ejected from the ejection port. As such, in the present embodiment, ink is ejected by the piezoelectric layers changing from the downward convex state to the flat state and then changing back to the downward convex state.

As described above, the piezoelectric actuator 22 in the present embodiment has the configuration including the three piezoelectric layers laminated in the Z direction and the three electrodes provided in different layers. If the piezoelectric actuator of Japanese Patent Laid-Open No. 2019-098614 and the piezoelectric actuator 22 of the present embodiment have the same thickness to achieve the same ejection effect, the thickness of each of the piezoelectric layers sandwiched between the electrodes in the piezoelectric actuator 22 is smaller than that in the piezoelectric actuator of Japanese Patent Laid-Open No. 2019-098614. Therefore, compared to the piezoelectric actuator of Japanese Patent Laid-Open No. 2019-098614, low-voltage drive can be performed, allowing for deformation of the piezoelectric layer with a smaller potential. By thus reducing the potential applied to the piezoelectric layer, electrical and mechanical deterioration that occurs in the piezoelectric actuator 22 during drive can be suppressed. As a result, the liquid ejection head 1 can suppress deterioration in ink ejection performance, ink circulation performance, and the ability to vibrate the meniscus formed in the ejection port, thus achieving more stable ejection performance over a long period of time than the piezoelectric actuator of Japanese Patent Laid-Open No. 2019-098614.

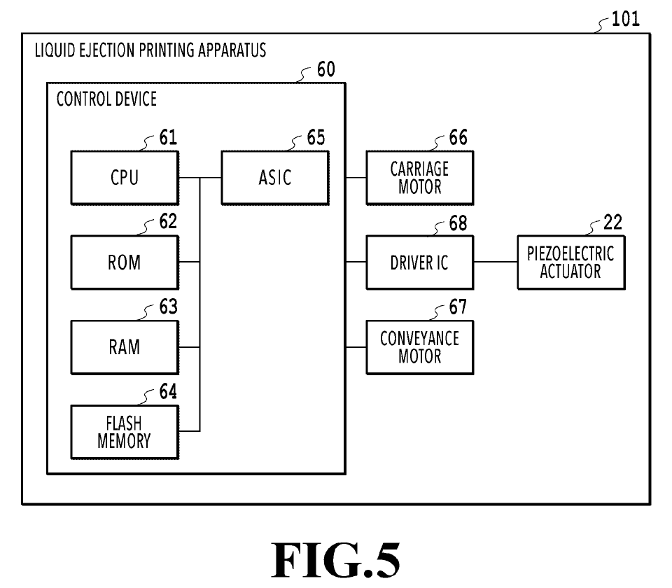

FIG. 5 is a block diagram showing a control system of the liquid ejection apparatus 101 to which the present embodiment can be applied. A control unit 60 includes a CPU 61, a ROM 62, a RAM 63, a flash memory 64, an ASIC 65, and the like, and controls operations of a carriage motor 66, a conveyance motor 67, a driver IC 68, and the like. Although FIG. 5 shows only one CPU 61, the control unit 60 may include a plurality of CPUs 61, and processing may be shared by the plurality of CPUs 61. Similarly, although FIG. 5 shows only one ASIC 65, the control unit 60 may include a plurality of ASICs 65, and processing may be shared by the plurality of ASICs 65.

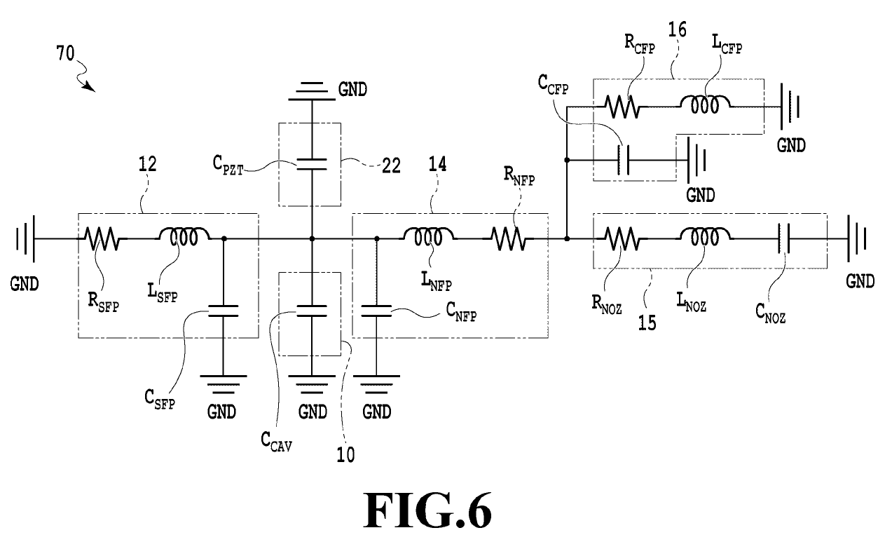

FIG. 6 is a diagram showing an equivalent circuit of fluid movement in the individual channel 20 and the piezoelectric actuator 22. The fluid movement in the individual channel 20 and the piezoelectric actuator 22 in the present embodiment can be represented by an equivalent circuit 70 shown in FIG. 6. The fluid movement through the channel, as in the liquid ejection apparatus, is expressed using pressure and volume displacement (the volume of liquid passing through the channel cross section) as variables, along with inertance, compliance, and channel resistance. Such a fluid movement model can be expressed by an electrical system model due to the similarity of equations of motion. As for the variables, the volume displacement is replaced with charge, and the pressure is replaced with voltage. The model elements are replaced with lumped-constant circuit elements, such as the inertance replaced with inductance (L), the compliance replaced with capacitance (C), and the channel resistance replaced with electrical resistance (R), making it possible to express the fluid movement model as an electric circuit model. The equivalent circuit 70 is thus obtained as a model for expressing movement and response by replacing elements with an electric circuit.

In the equivalent circuit 70, R_{SFP}, R_{NFP}, R_{NOZ}, and R_{CFP} are the channel resistances of the individual supply channel 12, the ejection passage 14, the ejection port 15, and the individual collecting channel 16. L_{SFP}, L_{NFP}, L_{NOZ}, and L_{CFP} are the inertances of the individual supply channel 12, the ejection passage 14, the ejection port 15, and the individual collecting channel 16. C_{SFP}, C_{CAV}, C_{PZT}, C_{NFP}, C_{CFP}, and C_{NOZ} are the compliances of the ink meniscus M (see FIG. 4C) formed in the individual supply channel 12, the individual pressure chamber 10, the piezoelectric actuator 22, the ejection passage 14, the individual collecting channel 16, and the ejection port 15. The channel resistance of the individual pressure chamber 10 is negligibly small compared to R_{SFP}, R_{NFP}, R_{NOZ}, and R_{CFP}. The inertances of the individual pressure chamber 10 and the piezoelectric actuator 22 are also negligibly small compared to L_{SFP}, L_{NFP}, L_{NOZ}, and L_{CFP}. The illustration thereof is therefore omitted in FIG. 6.

As for the inertance, L_{NFP} is greater than L_{NOZ}. As for the compliance, the sum of C_{CAV} and C_{PZT} (the sum of the compliance of the individual pressure chamber 10 and the compliance of the piezoelectric actuator 22) is greater than C_{SFP} (the compliance of the individual supply channel 12) and C_{NFP} (the compliance of the ejection passage 14). The sum of C_{CAV} and C_{PZT} (the sum of the compliance of the individual pressure chamber 10 and the compliance of the piezoelectric actuator 22) is smaller than C_{NOZ} (the compliance of the ink meniscus in the ejection port).

Furthermore, C_{SFP} (the compliance of the individual supply channel 12) is sufficiently smaller than C_{CAV} (the compliance of the individual pressure chamber 10), C_{PZT} (the compliance of the piezoelectric actuator 22), and C_{NFP} (the compliance of the ejection passage 14). C_{CFP} (the compliance of the individual collecting channel 16) is also sufficiently smaller than C_{CAV} (the compliance of the individual pressure chamber 10), C_{PZT} (the compliance of the piezoelectric actuator 22), and C_{NFP} (the compliance of the ejection passage 14). As for the attenuation coefficient R/L, the attenuation coefficient R_{CFP}/L_{CFP} of the individual collecting channel 16 is smaller than the attenuation coefficient R_{NOZ}/L_{NOZ} of the ejection port 15. The attenuation coefficient R/L represents how easily applied vibration is attenuated in a specific channel portion.

Here, the gains for the meniscus M of the ejection port 15 and the individual collecting channel 16 are calculated using the equivalent circuit 70. In this event, the drive frequency of the piezoelectric actuator 22 is changed within a range of 10 kHz to 1 MHz.

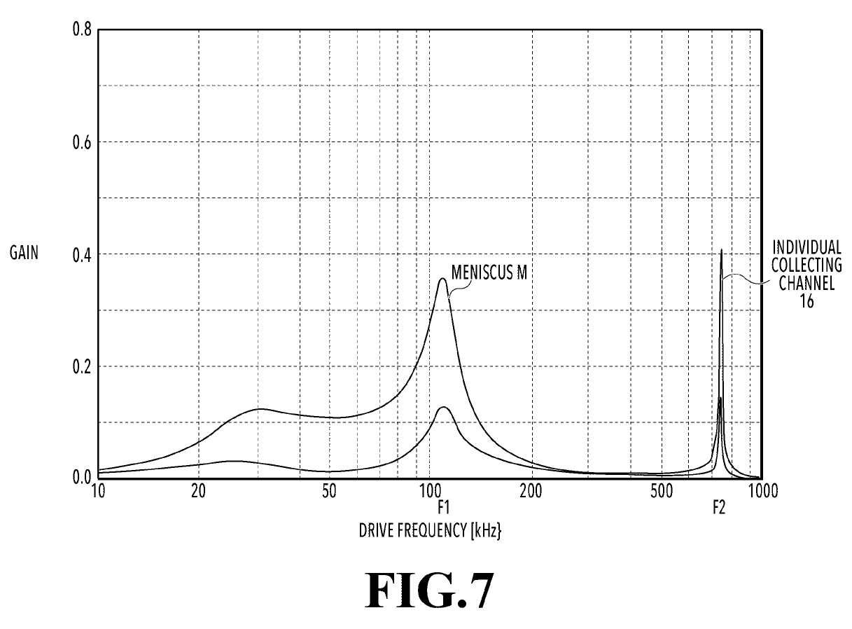

FIG. 7 is a graph showing an example of the relationship between gain and drive frequency for the meniscus M of the ejection port 15 and the individual collecting channel 16. In this example, the frequency profile for the meniscus M exhibits a high gain around 100 kHz. The individual collecting channel 16 exhibits a high gain around 750 kHz. As for the high gain frequencies, the former corresponds to the primary resonance frequency (“first resonance frequency” of the present disclosure) for the individual pressure chamber 10 and the piezoelectric actuator 22, and the latter corresponds to the primary resonance frequency (“second resonance frequency” of the present disclosure) for the ejection passage 14.

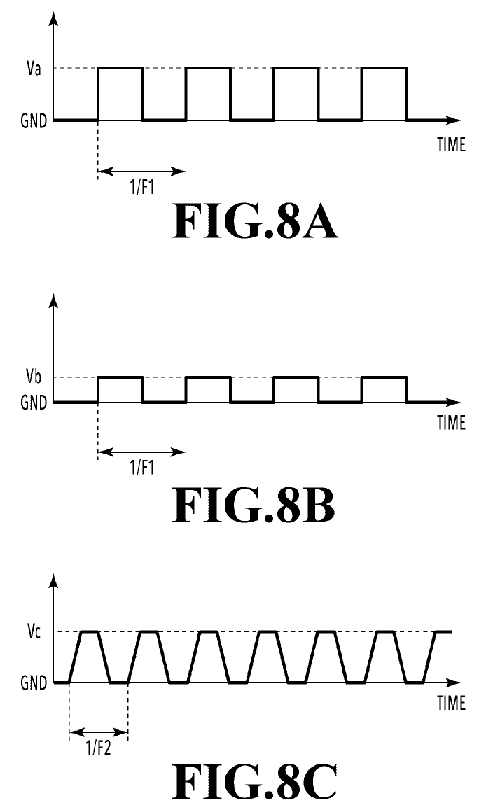

FIGS. 8A to 8C are charts each showing an example of a drive waveform of the piezoelectric actuator 22. The present embodiment is characterized in that the piezoelectric actuator 22 is driven at a specific frequency during ink ejection.

During ink ejection, the control unit 60 controls the driver IC 68 to apply a drive signal of the potential Va to the first electrode 51, as shown in FIG. 8A. While the potential Va is applied, the potential difference between the first electrode 51 and the second electrode 52 disappears, and the inner volume of the individual pressure chamber 10 increases. As the first electrode 51 is then switched from the potential Va to GND, the inner volume of the individual pressure chamber 10 decreases, and ink is ejected from the ejection port. The drive signal consists of a plurality of voltage pulses, and the frequency thereof is a first resonance frequency F1. The voltage pulses are rectangular pulses whose potential switches between the ground potential GND and the potential Va (≠ 0). The first resonance frequency F1 is the frequency at which the individual pressure chamber 10 and the piezoelectric actuator 22 resonate (see FIG. 7). Here, the first resonance frequency F1 is a resonance frequency that corresponds to the sum of the compliance of the individual pressure chamber 10 and the compliance of the piezoelectric actuator 22 [C_{CAV}+C_{PZT}]. [C_{CAV}+C_{PZT}] has a large difference from C_{SFP} and C_{NFP}. In a case of driving at this frequency, the individual pressure chamber 10 and the piezoelectric actuator 22 vibrate efficiently. This means that the ink can be efficiently ejected from the ejection port 15.

On the other hand, if a state where no ink is ejected continues, the ink thickens in the ejection port 15. This ink thickening leads to a change in ejection characteristics. Therefore, the meniscus M is vibrated to agitate the ink near the ejection port 15. Upon vibrating the meniscus M, the piezoelectric actuator 22 is driven at the first resonance frequency F1 (see FIG. 7). The control unit 60 controls the driver IC 68 to apply a drive signal of a potential Vb (<Va) to the first electrode 51, as shown in FIG. 8B. The drive signal consists of square-wave voltage pulses, and the potential thereof switches between the ground potential GND and the potential Vb (<Va). This allows the meniscus M to vibrate without ejecting ink. The vibration of the meniscus M agitates the ink near the ejection port 15, thus eliminating the ink thickening.

If the liquid ejection apparatus 101 is left unused for an extended period of time, pigment particles in the ink may precipitate. The precipitation of ink components may result in ejection failure. To counter this, in the present embodiment, the piezoelectric actuator 22 is used to circulate the ink from the individual channel 20 to the common channel 11 through the ejection passages 14. The liquid in the pressure chamber is thus circulated.

Upon circulating the ink, the piezoelectric actuator 22 is driven at a second resonance frequency F2. The second resonance frequency F2 is the frequency at which the ejection passage 14 resonates (see FIG. 7). The control unit 60 controls the driver IC 68 to apply a drive signal of a potential Vc to the first electrode 51, as shown in FIG. 8C. The drive signal consists of trapezoidal voltage pulses, and the potential thereof switches between the ground potential GND and the potential Vc. As a result, the ink in the common channel 11 flows from the individual supply channel 12 to the individual pressure chamber 10 and the ejection passage 14. The ink that reaches the ejection passage 14 returns to the common channel 11 through the individual collecting channel 16 and circulates. This ink circulation agitates the pigment particles, thus eliminating the precipitation.

Generally, the smaller the compliance, the higher the corresponding resonance frequency. In the present embodiment, C_{NFP} is smaller than [C_{CAV}+C_{PZT}]. In other words, the compliance of the ejection passage 14 is smaller than the sum of the compliance of the individual pressure chamber 10 and the compliance of the piezoelectric actuator 22. Correspondingly, the second resonance frequency F2 corresponding to C_{NFP} (the compliance of the ejection passage 14) is a higher resonance frequency than the first resonance frequency F1 corresponding to [C_{CAV}+C_{PZT}] (see FIG. 7). Specifically, the first resonance frequency F1 is about 100 kHz, and the second resonance frequency F2 is about 750 kHz.

In a case where the piezoelectric actuator 22 is driven at a certain frequency, if the frequency is the first resonance frequency F1, external input energy is effectively used to vibrate the individual pressure chamber 10 and the piezoelectric actuator 22. If the frequency is the second resonance frequency F2, the input energy is effectively used to vibrate the ejection passage 14. For other frequencies, the input energy is dispersed for vibration of various channel portions.

Typically, the time required to eliminate the precipitation of pigment particles is longer than the time required to eliminate the ink thickening. If the precipitation is eliminated (ink is circulated) at a frequency other than the second resonance frequency F2, the meniscus M will be exposed to vibration for longer than necessary. This may actually encourage the ink thickening throughout the entire liquid ejection head.

On the other hand, in the present embodiment, the piezoelectric actuator 22 is driven at the second resonance frequency F2. While the ejection passage 14 resonates, the ink can be circulated from the individual channel 20 to the common channel 11 through the ejection passage 14 in a state where the vibration of the meniscus M is minimized. Furthermore, by selectively using drive frequencies such as the first resonance frequency F1 and the second resonance frequency F2, the ink thickening near the ejection port 15 and the precipitation in the ink channel can be effectively eliminated.

Note that the elimination of the precipitation is affected by the ink flow velocity during circulation. The higher the drive frequency, the faster the flow velocity during circulation and the shorter the time required to eliminate the precipitation. A slow flow velocity takes time to eliminate the precipitation, raising concerns that the precipitation cannot be eliminated. On the other hand, in the present embodiment, the higher second resonance frequency F2 (> F1) is the drive frequency for ink circulation, allowing for efficient elimination of the precipitation.

Furthermore, as shown in FIG. 8C, trapezoidal waves are used as the drive signal for ink circulation. The drive signal contains few sinusoidal frequency components other than the second resonance frequency F2. Therefore, the input energy for ink circulation is effectively used to vibrate the ejection passage 14.

Generally, the greater the inertance, the less easily the liquid in the channel is displaced (the more easily the position is maintained). In the present embodiment, L_{CFP} (the inertance of the individual collecting channel 16) is greater than L_{NOZ} (the inertance of the ejection port 15). Therefore, in a case where the piezoelectric actuator 22 is driven to vibrate the meniscus M, the pressure generated in the individual pressure chamber 10 can be efficiently transmitted to the ejection port 15. Although the individual collecting channel 16 also communicates with the ejection passage 14, the relationship L_{CFP}>L_{NOZ} makes it difficult to transmit this pressure to the individual collecting channel 16. In particular, driving at the first resonance frequency F1 facilitates the use of input energy to vibrate the individual pressure chamber 10 and the piezoelectric actuator 22, thereby promoting this tendency.

In a case where ink is continuously ejected from the ejection port 15, from the perspective of stable ink ejection, it is preferable that the residual vibration of the meniscus M be sufficiently attenuated immediately before the ink is ejected. In the present embodiment, the ejection port 15 has a large attenuation coefficient R_{NOZ}/L_{NOZ}, and thus the residual vibration of the meniscus M is quickly attenuated. This makes it possible to reduce the ink ejection interval. On the other hand, in the present embodiment, the individual collecting channel 16 has a small attenuation coefficient R_{CFP}/L_{CFP}. Upon ink circulation, the force for displacing the ink is not easily attenuated, making it possible to efficiently carry on the ink circulation.

In the present embodiment, the piezoelectric actuator has, but is not limited to, the configuration including the three laminated piezoelectric layers and the three electrodes provided so as to sandwich the piezoelectric layers therebetween in the laminated direction. The piezoelectric actuator may have any configuration including a plurality of laminated piezoelectric layers and three electrodes provided so as to sandwich the piezoelectric layers therebetween in the laminated direction.

To achieve the printing volume required in the industrial and commercial fields, for example, if the total number of piezoelectric actuators driven for ink ejection is 1, the total number of piezoelectric actuators driven for meniscus vibration and ink circulation is required to be 10 to 100. In other words, 10 to 100 times the total number of piezoelectric actuators driven for ink ejection is used for meniscus vibration and ink circulation. On the other hand, the piezoelectric actuator having the configuration including a plurality of laminated piezoelectric layers, as in the present embodiment, makes it possible to achieve the required total number of piezoelectric actuators to be driven, while suppressing actuator deterioration.

In the present embodiment, the piezoelectric actuator has the configuration including the three laminated piezoelectric layers and the three electrodes provided so as to sandwich the piezoelectric layers therebetween in the laminated direction. This enables the piezoelectric layers to be displaced with a smaller drive voltage than the related art. This makes it possible to provide a liquid ejection head capable of suppressing piezoelectric actuator deterioration and achieving stable ejection performance. Note that the present disclosure is not limited to the above-described embodiment, and various modifications are possible within the scope of the claims.

### Second Embodiment

A second embodiment of the present disclosure will be described below with reference to the drawings. Since the basic configuration of the present embodiment is the same as that of the first embodiment, only characteristic configurations will be described below.

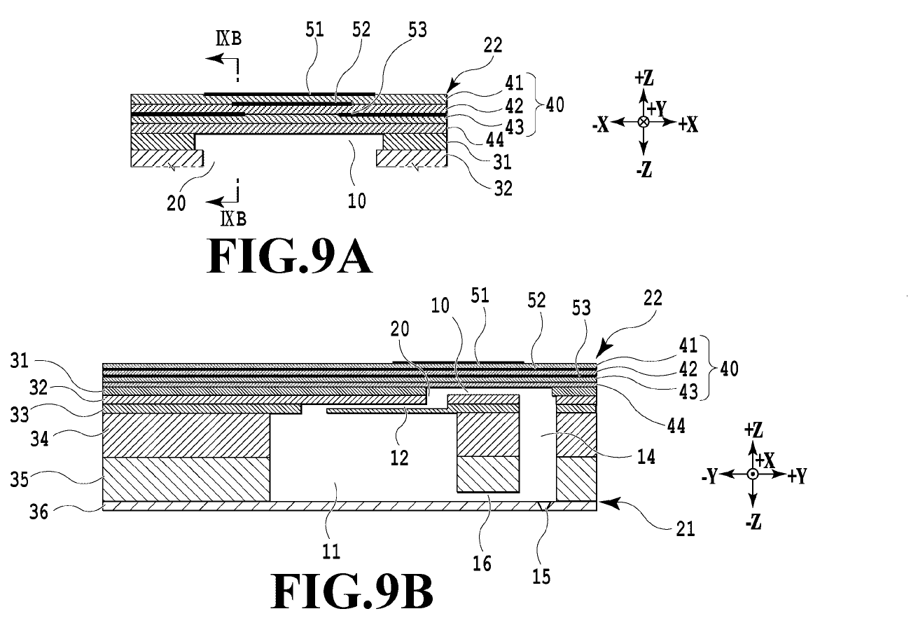

FIG. 9A is a cross-sectional view of the piezoelectric actuator 22 taken along line IVA-IVA in FIG. 3. FIG. 9B is a cross-sectional view of the channel unit 21 and the piezoelectric actuator 22 taken along line IVB-IVB in FIG. 3. The channel unit 21 has the same configuration as that of the first embodiment.

The piezoelectric actuator 22 in the present embodiment includes: a piezoelectric body 40 having a plurality of piezoelectric layers laminated in the Z direction; a first electrode 51; a second electrode 52 spaced apart from the first electrode 51 in the Z direction; and a third electrode 53 spaced apart from the first electrode 51 in the Z direction. Here, the direction toward one end of the ejection port array is defined as a +X direction, and the direction toward the other end of the ejection port array is defined as a -X direction. As shown in FIG. 9A, the piezoelectric actuator 22, as viewed from the +Y direction, has a portion where both end portions of the first electrode 51 in the X direction do not overlap with the second electrode 52 in the Z direction, but overlap with the third electrode 53. The piezoelectric actuator 22 also has a portion where both end portions of the second electrode 52 in the X direction overlap with the first electrode 51 and the third electrode 53 in the Z direction, and the portion of the second electrode 52 other than both end portions in the X direction overlaps with the first electrode 51 but does not overlap with the third electrode 53.

Before the liquid ejection head 1 is operated, the first electrode 51 and the third electrode 53 are set to GND, and the potential Va is applied to the second electrode 52. At this time, a potential difference between the first electrode 51 and the second electrode 52 generates an upward electric field in the piezoelectric layer 41 sandwiched between the first electrode 51 and the second electrode 52, the electric field being equal to the polarization direction of the piezoelectric layer 41. This causes the piezoelectric layer 41 to contract and warp in the XY plane. As a result, the piezoelectric body 40 having the plurality of piezoelectric layers laminated in the Z direction and the ink separation layer 44 become convex downward toward the individual pressure chamber 10, and the inner volume of the individual pressure chamber 10 becomes smaller than that in a case where the piezoelectric body 40 is flat.

In a case of operating the liquid ejection head 1 to eject ink from the ejection port, the potential of the first electrode 51 is switched from GND to the potential Va. In this event, the potential difference between the first electrode 51 and the second electrode 52 is eliminated, releasing the contraction of the piezoelectric layer 41 between the first electrode 51 and the second electrode 52. Meanwhile, a potential difference is created between the first electrode 51 and the third electrode 53, generating a downward electric field equal to the polarization direction in the piezoelectric layers 41 and 42 sandwiched therebetween, causing the piezoelectric layers to contract in the XY plane. As a result, the piezoelectric body 40 having the plurality of piezoelectric layers laminated in the Z direction is pulled upward, and the piezoelectric actuator 22 becomes convex in the +Z direction (convex upward). As a result, the inner volume of the individual pressure chamber 10 becomes larger than that in a case where the piezoelectric body 40 is flat, and the amount of ink in the individual pressure chamber 10 increases.

Thereafter, as the corresponding first electrode 51 is switched from the potential Va to GND, the potential difference between the first electrode 51 and the second electrode 52 causes the piezoelectric layer 41 between the first electrode 51 and the second electrode 52 to contract in the XY plane, as with before operation. Then, the potential difference between the second electrode 52 and the third electrode 53 disappears, and thus the contraction of the piezoelectric layer 42 between the second electrode 52 and the third electrode 53 is released. As a result, the increased inner volume of the individual pressure chamber 10 returns to its original state before operation, and the ink increased in the individual pressure chamber 10 is ejected from the ejection port 15.

An example of a drive waveform during ejection is as shown in FIG. 8A. In a case of vibrating the meniscus M and circulating the liquid in the pressure chamber, the drive shown in FIGS. 8B and 8C may be employed, as in the first embodiment. As such, in the present embodiment, ink is ejected by the piezoelectric layers changing from the downward convex state to the upward convex state and then changing back to the downward convex state.

If the piezoelectric actuator of Japanese Patent Laid-Open No. 2019-098614 and the piezoelectric actuator 22 of the present embodiment have the same thickness, the thickness of each of the piezoelectric layers sandwiched between the electrodes in the piezoelectric actuator 22 is smaller than that in the piezoelectric actuator of Japanese Patent Laid-Open No. 2019-098614. Therefore, compared to the piezoelectric actuator of Japanese Patent Laid-Open No. 2019-098614, low-voltage drive can be performed, allowing for deformation of the piezoelectric layer with a smaller potential. By thus reducing the voltage applied to the piezoelectric layer (reducing the potential applied to the piezoelectric layer), electrical and mechanical deterioration that occurs in the piezoelectric actuator 22 during drive can be suppressed. As a result, the liquid ejection head 1 can suppress deterioration in ink ejection performance, ink circulation performance, and the ability to vibrate the meniscus formed in the ejection port, thus achieving more stable ejection performance over a long period of time than the piezoelectric actuator of Japanese Patent Laid-Open No. 2019-098614.

### Third Embodiment

A third embodiment of the present disclosure will be described below with reference to the drawings. Since the basic configuration of the present embodiment is the same as that of the first embodiment, only characteristic configurations will be described below.

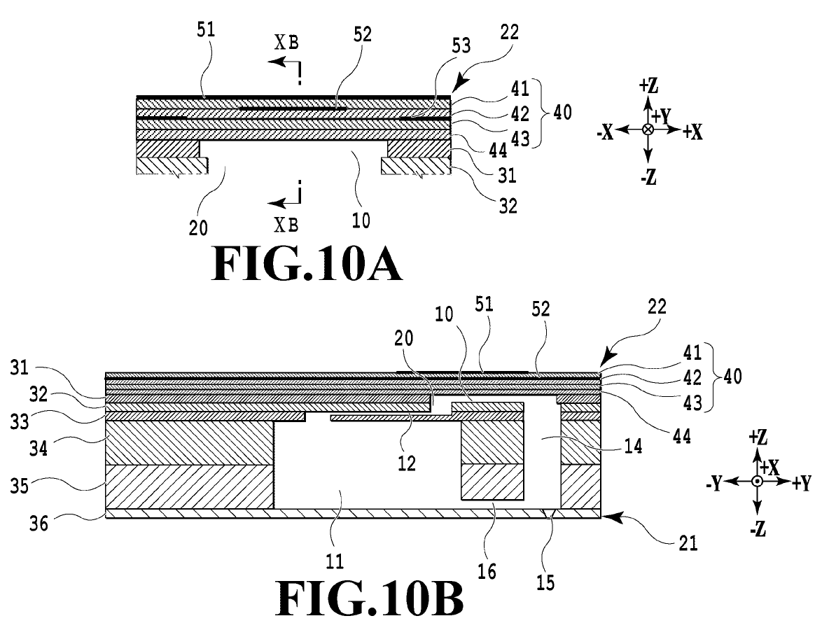

FIG. 10A is a cross-sectional view of the piezoelectric actuator 22 taken along line IVA-IVA in FIG. 3. FIG. 10B is a cross-sectional view of the channel unit 21 and the piezoelectric actuator 22 taken along line IVB-IVB in FIG. 3. The channel unit 21 has the same configuration as that of the first embodiment.

The piezoelectric actuator 22 in the present embodiment includes: a piezoelectric body 40 having a plurality of piezoelectric layers laminated in the Z direction; a first electrode 51; a second electrode 52 spaced apart from the first electrode 51 in the Z direction; and a third electrode 53 spaced apart from the first electrode 51 in the Z direction. As shown in FIG. 10A, the piezoelectric actuator 22, as viewed from the +Y direction, has a portion where both end portions of the first electrode 51 in the X direction do not overlap with the second electrode 52 in the Z direction, but overlap with the third electrode 53. The piezoelectric actuator 22 also has a portion where the second electrode 52 overlaps with the first electrode 51 but does not overlap with the third electrode 53 in the Z direction.

Before the liquid ejection head 1 is operated, the first electrode 51 and the third electrode 53 are set to GND, and the potential Va is applied to the second electrode 52. At this time, a potential difference between the first electrode 51 and the second electrode 52 generates an upward electric field equal to the polarization direction in the piezoelectric layer 41 sandwiched between the first electrode 51 and the second electrode 52. This causes the piezoelectric layer 41 to contract and warp in the XY plane. Accordingly, the piezoelectric body 40 having the plurality of piezoelectric layers laminated in the Z direction and the ink separation layer 44 become convex downward toward the individual pressure chamber 10, in the portion overlapping with the individual pressure chamber 10 in the Z direction. As a result, the inner volume of the individual pressure chamber 10 becomes smaller than that in a case where the piezoelectric body 40 is flat.

In a case of operating the liquid ejection head 1 to eject ink from the ejection port, the potential of the first electrode 51 is switched from GND to the potential Va. In this event, the potential difference between the first electrode 51 and the second electrode 52 disappears, and thus the contraction of the piezoelectric layer 41 between the first electrode 51 and the second electrode 52 is released. Meanwhile, a potential difference is created between the first electrode 51 and the third electrode 53, and a downward electric field equal to the polarization direction is generated in the piezoelectric layers 41 and 42 sandwiched therebetween, causing contraction in the XY plane. Accordingly, the piezoelectric body 40 having the plurality of piezoelectric layers laminated in the Z direction is pulled upward in the portion overlapping with the individual pressure chamber 10, and the piezoelectric actuator 22 becomes convex in the +Z direction. As a result, the inner volume of the individual pressure chamber 10 becomes larger, and the amount of ink in the individual pressure chamber 10 increases.

Thereafter, as the corresponding first electrode 51 is switched from the potential Va to GND, the potential difference between the first electrode 51 and the second electrode 52 causes the piezoelectric layer 41 between the first electrode 51 and the second electrode 52 to contract in the XY plane, as with before operation. Then, the potential difference between the second electrode 52 and the third electrode 53 disappears, and thus the contraction of the piezoelectric layer 42 between the second electrode 52 and the third electrode 53 is released. As a result, the increased inner volume of the individual pressure chamber 10 returns to the downward convex state, and the ink increased in the individual pressure chamber 10 is ejected from the ejection port 15.

An example of a drive waveform during ejection is as shown in FIG. 8A. In a case of vibrating the meniscus M and circulating the liquid in the pressure chamber, the drive shown in FIGS. 8B and 8C may be employed, as in the first embodiment. If the piezoelectric actuator of Japanese Patent Laid-Open No. 2019-098614 and the piezoelectric actuator 22 of the present embodiment have the same thickness, the thickness of each of the piezoelectric layers sandwiched between the electrodes in the piezoelectric actuator 22 is smaller than that in the piezoelectric actuator of Japanese Patent Laid-Open No. 2019-098614. Therefore, compared to the piezoelectric actuator of Japanese Patent Laid-Open No. 2019-098614, low-voltage drive can be performed, allowing for deformation of the piezoelectric layer with a smaller potential. By thus reducing the potential applied to the piezoelectric layer, electrical and mechanical deterioration that occurs in the piezoelectric actuator 22 during drive can be suppressed. As a result, the liquid ejection head 1 can suppress deterioration in ink ejection performance, ink circulation performance, and the ability to vibrate the meniscus formed in the ejection port, thus achieving more stable ejection performance over a long period of time than the piezoelectric actuator of Japanese Patent Laid-Open No. 2019-098614.

### Fourth Embodiment

A fourth embodiment of the present disclosure will be described below with reference to the drawings. Since the basic configuration of the present embodiment is the same as that of the first embodiment, only characteristic configurations will be described below.

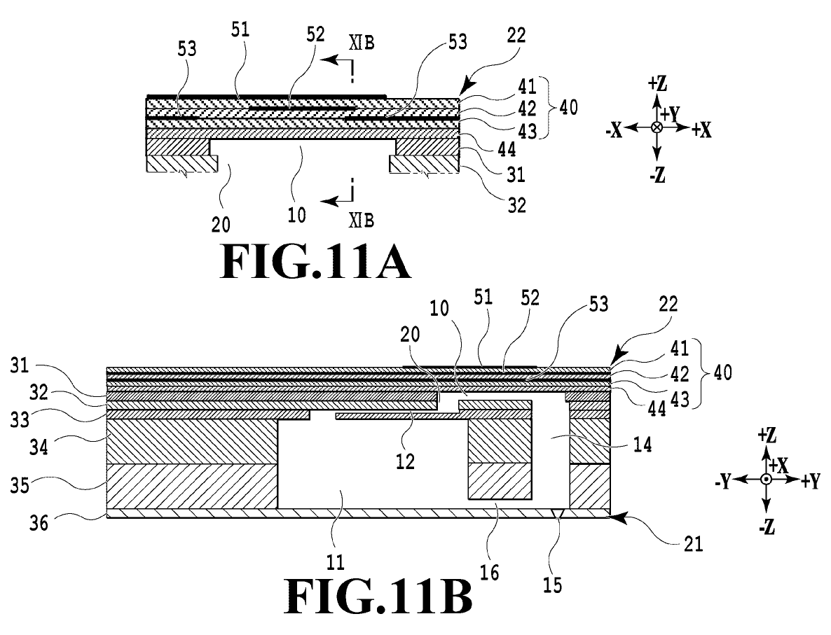

FIG. 11A is a cross-sectional view of the piezoelectric actuator 22 taken along line IVA-IVA in FIG. 3. FIG. 11B is a cross-sectional view of the channel unit 21 and the piezoelectric actuator 22 taken along line IVB-IVB in FIG. 3. The channel unit 21 has the same configuration as that of the first embodiment.

The piezoelectric actuator 22 in the present embodiment includes: a piezoelectric body 40 having a plurality of piezoelectric layers laminated in the Z direction; a first electrode 51; a second electrode 52 spaced apart from the first electrode 51 in the Z direction; and a third electrode 53 spaced apart from the first electrode 51 in the Z direction. As shown in FIG. 11A, the piezoelectric actuator 22, as viewed from the +Y direction, has a portion where an end portion of the first electrode 51 in the -X direction does not overlap with the second electrode 52 but overlaps with the third electrode 53 in the Z direction. The first electrode 51 overlaps with the second electrode 52 and the third electrode 53. The piezoelectric actuator 22 also has a portion where the second electrode 52 overlaps with the first electrode 51 but does not overlap with the third electrode 53 in the Z direction. Moreover, the second electrode 52 overlaps with the first electrode 51 and the third electrode 53 in the Z direction, in the end portion thereof in the +X direction. Furthermore, in the end portion of the piezoelectric actuator 22 in the +X direction, the third electrode 53 does not overlap with the first electrode 51 or the second electrode 52 in the Z direction.

Before the liquid ejection head 1 is operated, the first electrode 51 and the third electrode 53 are set to GND, and the potential Va is applied to the second electrode 52. At this time, a potential difference between the first electrode 51 and the second electrode 52 generates an upward electric field equal to the polarization direction in the piezoelectric layer 41 sandwiched between the first electrode 51 and the second electrode 52. This causes the piezoelectric layer 41 to contract and warp in the XY plane. Accordingly, the piezoelectric body 40 having the plurality of piezoelectric layers laminated in the Z direction and the ink separation layer 44 become convex downward toward the individual pressure chamber 10, in the portion overlapping with the individual pressure chamber 10 in the Z direction. As a result, the inner volume of the individual pressure chamber 10 becomes smaller than that in a case where the piezoelectric body 40 is flat.

In a case of operating the liquid ejection head 1 to eject ink from the ejection port, the potential of the first electrode 51 is switched from GND to the potential Va. In this event, the potential difference between the first electrode 51 and the second electrode 52 disappears, and thus the contraction of the piezoelectric layer 41 between the first electrode 51 and the second electrode 52 is released. Meanwhile, a potential difference is created between the first electrode 51 and the third electrode 53, and a downward electric field equal to the polarization direction is generated in the piezoelectric layers 41 and 42 sandwiched therebetween, causing contraction in the XY plane. Accordingly, the piezoelectric body 40 having the plurality of piezoelectric layers laminated in the Z direction is pulled upward in the portion overlapping with the individual pressure chamber 10, and the piezoelectric actuator 22 becomes convex in the +Z direction. As a result, the inner volume of the individual pressure chamber 10 becomes larger, and the amount of ink in the individual pressure chamber 10 increases.

Thereafter, as the corresponding first electrode 51 is switched from the potential Va to GND, the potential difference between the first electrode 51 and the second electrode 52 causes the piezoelectric layer 41 between the first electrode 51 and the second electrode 52 to contract in the XY plane, as with before operation. Then, the potential difference between the second electrode 52 and the third electrode 53 disappears, and thus the contraction of the piezoelectric layer 42 between the second electrode 52 and the third electrode 53 is released. As a result, the increased inner volume of the individual pressure chamber 10 returns to the downward convex state, and the ink increased in the individual pressure chamber 10 is ejected from the ejection port 15.

An example of a drive waveform during ejection is as shown in FIG. 8A. In a case of vibrating the meniscus M and circulating the liquid in the pressure chamber, the drive shown in FIGS. 8B and 8C may be employed, as in the first embodiment. If the piezoelectric actuator of Japanese Patent Laid-Open No. 2019-098614 and the piezoelectric actuator 22 of the present embodiment have the same thickness, the thickness of each of the piezoelectric layers sandwiched between the electrodes in the piezoelectric actuator 22 is smaller than that in the piezoelectric actuator of Japanese Patent Laid-Open No. 2019-098614. Therefore, compared to the piezoelectric actuator of Japanese Patent Laid-Open No. 2019-098614, low-voltage drive can be performed, allowing for deformation of the piezoelectric layer with a smaller potential. By thus reducing the potential applied to the piezoelectric layer, electrical and mechanical deterioration that occurs in the piezoelectric actuator 22 during drive can be suppressed. As a result, the liquid ejection head 1 can suppress deterioration in ink ejection performance, ink circulation performance, and the ability to vibrate the meniscus formed in the ejection port, thus achieving more stable ejection performance over a long period of time than the piezoelectric actuator of Japanese Patent Laid-Open No. 2019-098614.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-065450, filed Apr. 11, 2025, which is hereby incorporated by reference herein in its entirety.

What is claimed is:

1. A liquid ejection head comprising:
an ejection port for ejecting a liquid;
a pressure chamber communicating with the ejection port;
a piezoelectric actuator for applying pressure to the liquid contained in the pressure chamber;
an ejection passage connecting the pressure chamber to the ejection port;
a common channel capable of containing the liquid to be supplied to a plurality of the pressure chambers;
an individual supply channel for supplying the liquid from the common channel to the pressure chamber; and
an individual collecting channel for collecting the liquid from the ejection passage to the common channel, wherein
the piezoelectric actuator has a plurality of piezoelectric layers laminated in a laminated direction, and a first electrode, a second electrode, and a third electrode, which are provided at different positions in the laminated direction so as to sandwich the piezoelectric layers different from each other.

2. The liquid ejection head according to claim 1, wherein
the plurality of piezoelectric layers are a first piezoelectric layer, a second piezoelectric layer, and a third piezoelectric layer, and
the first piezoelectric layer is sandwiched between the first electrode and the second electrode, and the second piezoelectric layer is sandwiched between the second electrode and the third electrode.

3. The liquid ejection head according to claim 1, wherein
the piezoelectric actuator is driven to circulate the liquid between the common channel and the pressure chamber through the individual supply channel and the individual collecting channel.

4. The liquid ejection head according to claim 1, wherein
the piezoelectric actuator is driven to vibrate a meniscus formed in the ejection port.

5. The liquid ejection head according to claim 4, wherein
the piezoelectric actuator is driven using a rectangular wave to vibrate the meniscus, and the piezoelectric actuator is driven using a trapezoidal wave to circulate the liquid in the pressure chamber through the individual collecting channel.

6. The liquid ejection head according to claim 5, wherein
in a case of vibrating the meniscus, the piezoelectric actuator is driven at a first resonance frequency associated with the pressure chamber and the piezoelectric actuator.

7. The liquid ejection head according to claim 6, wherein
in a case of ejecting the liquid, the piezoelectric actuator is driven using a rectangular wave of a drive voltage higher than that in the case of vibrating the meniscus, below the first resonance frequency.

8. The liquid ejection head according to claim 6, wherein
the piezoelectric actuator is driven at a second resonance frequency different from the first resonance frequency associated with the individual collecting channel, in a case of circulating the liquid in the pressure chamber through the individual collecting channel.

9. The liquid ejection head according to claim 6, wherein
a sum of a compliance of the pressure chamber and a compliance of the piezoelectric actuator is greater than a compliance of the individual supply channel and a compliance of the ejection passage, and smaller than a compliance of the meniscus of the liquid in the ejection port, and
the first resonance frequency is a resonance frequency corresponding to the sum of the compliance of the pressure chamber and the compliance of the piezoelectric actuator.

10. The liquid ejection head according to claim 8, wherein
a compliance of the ejection passage is greater than a compliance of the individual collecting channel, and
the second resonance frequency is a frequency corresponding to the compliance of the ejection passage.

11. The liquid ejection head according to claim 8, wherein
a compliance of the ejection passage is smaller than a sum of a compliance of the pressure chamber and a compliance of the piezoelectric actuator, and
the second resonance frequency is higher than the first resonance frequency.

12. The liquid ejection head according to claim 1, wherein
the individual collecting channel has a larger inertance than the ejection port.

13. The liquid ejection head according to claim 1, wherein
the individual collecting channel has a smaller attenuation coefficient than the ejection port, the attenuation coefficient being obtained by dividing channel resistance by inertance.

14. The liquid ejection head according to claim 2, wherein
the ejection ports are arrayed to form an ejection port array, and
as viewed from a Y direction, where
an X direction is a direction in which the ejection ports are arrayed,
the Y direction is a direction intersecting with the X direction in a plane in which the ejection ports are provided, and
a Z direction is a direction in which the liquid is ejected,
the piezoelectric actuator has a portion in which
both end portions of the first electrode in the X direction do not overlap with the second electrode but overlap with the third electrode in the Z direction,
both end portions of the second electrode in the X direction overlap with the first electrode and the third electrode in the Z direction, and
a portion of the second electrode other than both end portions in the X direction overlaps with the first electrode but does not overlap with the third electrode.

15. The liquid ejection head according to claim 2, wherein
the ejection ports are arrayed to form an ejection port array, and
as viewed from a Y direction, where
an X direction is a direction in which the ejection ports are arrayed,
the Y direction is a direction intersecting with the X direction in a plane in which the ejection ports are provided, and
a Z direction is a direction in which the liquid is ejected,
the piezoelectric actuator has
a portion in which both end portions of the first electrode in the X direction do not overlap with the second electrode and overlap with the third electrode in the Z direction,
a portion in which the first electrode does not overlap with the second electrode and the third electrode in the Z direction, and
a portion in which the second electrode overlaps with the first electrode but does not overlap with the third electrode in the Z direction.

16. The liquid ejection head according to claim 2, wherein
the ejection ports are arrayed to form an ejection port array, and
as viewed from a Y direction, where
in an X direction in which the ejection ports are arranged, a +X direction is a direction toward one end side of the ejection port array and a -X direction is a direction toward the other end side of the ejection port array,
the Y direction is a direction intersecting with the X direction in a plane in which the ejection ports are provided, and
a Z direction is a direction in which the liquid is ejected,
the piezoelectric actuator has
a portion in which an end portion of the first electrode in the -X direction does not overlap with the second electrode but overlaps with the third electrode in the Z direction,
a portion in which the first electrode does not overlap with the second electrode and the third electrode in the Z direction,
a portion in which the second electrode overlaps with the first electrode but does not overlap with the third electrode in the Z direction,
a portion in which the second electrode overlaps with the first electrode and the third electrode in the Z direction, in an end portion thereof in the +X direction, and
a portion in which the third electrode does not overlap with the first electrode or the second electrode in the Z direction, in an end portion of the piezoelectric actuator in the +X direction.

17. A liquid ejection apparatus capable of mounting a liquid ejection head including
an ejection port array in which a plurality of ejection ports for ejecting a liquid are arrayed,
a pressure chamber for applying pressure to the liquid,
an ejection passage provided between the pressure chamber and the ejection ports and capable of transmitting pressure generated in the pressure chamber to the ejection ports,
a common channel through which the liquid to be supplied to the pressure chamber flows,
an individual supply channel through which the liquid to be supplied from the common channel to the pressure chamber flows,
an individual channel connecting the individual supply channel to the pressure chamber,
an individual collecting channel connecting the ejection passage to the common channel, and
a piezoelectric actuator for generating pressure on the liquid in the pressure chamber,
the liquid ejection apparatus comprising:
a conveying unit for conveying a printing medium; and
a control unit for controlling driving of the piezoelectric actuator, wherein
the piezoelectric actuator has a plurality of piezoelectric layers laminated in a laminated direction, and a first electrode, a second electrode, and a third electrode, which are provided at different positions in the laminated direction so as to sandwich the piezoelectric layers different from each other,
the control unit drives the piezoelectric actuator at a first resonance frequency at which the pressure chamber resonates, to which the piezoelectric actuator is added in the individual channels, in a case of vibrating a meniscus of the liquid formed in the ejection port, and
the control unit drives the piezoelectric actuator at a second resonance frequency at which the ejection passage resonates, in a case of circulating the liquid through the pressure chamber and the common channel.

18. The liquid ejection apparatus according to claim 17, wherein
a compliance of the ejection passage is greater than a compliance of the individual collecting channel, and
the second resonance frequency is a frequency corresponding to the compliance of the ejection passage.

19. The liquid ejection apparatus according to claim 17, wherein
a compliance of the ejection passage is smaller than a sum of a compliance of the pressure chamber and a compliance of the piezoelectric actuator, and
the second resonance frequency is higher than the first resonance frequency.

20. The liquid ejection apparatus according to claim 17, wherein
the individual collecting channel has a larger inertance than the ejection port.
